(19) United States
(12) Patent Application Publication
(10) Pub. No.: US 2020/0027418 A1
(43) Pub. Date: Jan. 23, 2020

(54) DISPLAY DEVICE AND DRIVING METHOD OF THE SAME

(71) Applicant: Samsung Display Co., Ltd., Yongin-Si (KR)

(72) Inventors: Kyunho KIM, Hwaseong-si (KR); Sangan KWON, Cheonan-si (KR); Sungjin KIM, Gwangju (KR); Subin PARK, Hwaseong-si (KR); Neung-Beom LEE, Hwaseong-si (KR)

(21) Appl. No.: 16/401,518

(22) Filed: May 2, 2019

(30) Foreign Application Priority Data
Jul. 17, 2018 (KR) 10-2018-0082944

(51) Int. Cl. G09G 3/36; G09G 3/3275; G09G 3/3225

(52) U.S. Cl. CPC G09G 3/3696; G09G 3/3688; G09G 2310/08; G09G 3/3225; G09G 3/3275

(57) ABSTRACT

A display device includes a display panel including a plurality of pixels, a voltage generator which generates a gate on voltage having a first voltage level that satisfies a target charging ratio of a pixel of the plurality of pixels, a voltage controller which receives an image signal and generates a voltage control signal when the image signal includes a predetermined reference pattern, a gate driver which generates a gate signal provided to the plurality of pixels based on the gate on voltage, a data driver which generates a data signal provided to the of the plurality of pixels based on the image signal, and a timing controller which generates control signals that control the gate driver and the data driver. The voltage generator changes the gate on voltage to have a second voltage level lower than the first voltage level based on the voltage control signal.

This application claims priority to Korean Patent Application No. 10-2018-0082944, filed on Jul. 17, 2018, and all the benefits accruing therefrom under 35 U.S.C. § 119, the content of which in its entirety is herein incorporated by reference.

### BACKGROUND

### 1. Field

Example embodiments relate generally to a display device and a driving method of the same.

### 2. Description of the Related Art

Recently, flat panel display (“FPD”) devices are widely used as a display device of electronic devices because the FPD devices are relatively lightweight and thin compared to cathode-ray tube (“CRT”) display devices. Examples of the FPD devices include liquid crystal display (“LCD”) devices, field emission display (“FED”) devices, plasma display panel (“PDP”) devices, and organic light emitting display (“OLED”) devices.

A display device may include a plurality of pixels. Each of the plurality of pixels may include a storage capacitor that stores a data voltage corresponding to an image signal.

### SUMMARY

When a charging ratio of a pixel decreases due to a high frequency driving, a variation of a display panel, etc., a display defect (e.g., luminance in low grayscales is reversed) may occur. Although a method for improving the charging ratio of the pixel by increasing a voltage level of a gate on voltage is used, a horizontal line defect may occur in a high temperature environment or in an image having high luminance as the voltage level of the gate on voltage increases.

Some example embodiments provide a display device capable of improving display quality due to an increase of a gate on voltage.

Some example embodiments provide a driving method of a display device capable of improving display quality due to an increase of a gate on voltage.

According to an example embodiment, a display device may include a display panel including a plurality of pixels, a voltage generator which generates a gate on voltage having a first voltage level that satisfies a target charging ratio of a pixel of the plurality of pixels, a voltage controller which receives an image signal and generates a voltage control signal when the image signal includes a predetermined reference pattern, a gate driver which generates a gate signal provided to the plurality of pixels based on the gate on voltage, a data driver which generates a data signal provided to the plurality of pixels based on the image signal, and a timing controller which generates control signals that control the gate driver and the data driver. The voltage generator may change the gate on voltage to have a second voltage level lower than the first voltage level based on the voltage control signal.

In an example embodiment, the voltage controller may output the voltage control signal when the predetermined reference pattern is detected more than a predetermined number of detection times.

In an example embodiment, the voltage generator may sequentially change the gate on voltage from the first voltage level to the second voltage level based on the voltage control signal.

In an example embodiment, the voltage generator may further generate a gate off voltage having a third voltage level that satisfies the target charging ratio of the pixel, and change the gate off voltage to have a fourth voltage level higher than the third voltage level based on the voltage control signal.

In an example embodiment, the voltage generator may further generate a common voltage having a third voltage level that is an optimum common voltage of the pixel, and change the common voltage to have a fourth voltage level lower than the third voltage level based on the voltage control signal.

In an example embodiment, the voltage controller may include a frame memory which stores the image signal per frame and a pattern detector which determines whether the image signal includes the predetermined reference pattern.

In an example embodiment, the pattern detector may determine that the image signal includes the predetermined reference pattern when a number of data toggle is equal to or greater than a predetermined reference number in the image signal.

In an example embodiment, the pattern detector may determine that the image signal includes the predetermined reference pattern when a number of data having a grayscale equal to or greater than a predetermined reference grayscale is equal to or greater than a predetermined reference number in the image signal.

In an example embodiment, the voltage controller further may include a pattern memory. The pattern memory may determine whether the image signal includes the predetermined reference pattern by comparing the image signal and the predetermined reference pattern stored in the pattern memory.

In an example embodiment, the voltage controller may be included in the timing controller.

In an example embodiment, the voltage controller may be coupled to the timing controller.

In an example embodiment, the predetermined reference pattern may be a pattern that causes a display defect when the gate on voltage having the first voltage level is provided to the pixel.

According to an example embodiment, a driving method of a display device may include an operation of determining whether an image signal includes a predetermined reference pattern, an operation of generating a voltage control signal when the image signal includes the predetermined reference pattern, and an operation of changing a voltage level of a gate on voltage having a first voltage level that satisfies a target charging ratio of a pixel to a second voltage level lower than the first voltage level based on the voltage control signal.

In an example embodiment, when the predetermined reference pattern is detected more than a predetermined number of detection times, the voltage control signal may be output.

In an example embodiment, the driving method of the display device may further include changing a voltage level of a gate off voltage having a third voltage level that satisfies the target charging ratio to a fourth voltage level higher than the third voltage level based on the voltage control signal.

In an example embodiment, the driving method of the display device may further include changing a voltage level of a common voltage having a third voltage level that is an optimum common voltage level to a fourth voltage level lower than the third voltage level based on the voltage control signal.

In example embodiments, the determining whether the image signal includes the predetermined reference pattern may include determining that the image signal includes the predetermined reference pattern when a number of data toggle is equal to or greater than a predetermined reference number in the image signal.

In an example embodiment, the determining whether the image signal includes the predetermined reference pattern may include determining that the image signal includes the predetermined reference pattern when a number of data having a grayscale equal to or greater than a predetermined reference grayscale is equal to or greater than a predetermined reference number in the image signal.

In an example embodiment, the determining whether the image signal includes the predetermined reference pattern may include comparing the image signal to the predetermined reference pattern stored in the display device.

In an example embodiment, the predetermined reference pattern is a pattern that causes a display defect when the gate on voltage having the first voltage level is provided to the pixel.

Therefore, the display device and the driving method of the display device may improve the display quality by providing the gate on voltage having the first voltage level that satisfies the target charging ratio of the pixel when a general image is provided. Further, the display device and the driving method of the display device may improve display defects occurred by an increase of a sing depth of the gate signal by changing the voltage level of the gate on voltage to the second voltage level lower than the first voltage level when the image that includes the reference pattern is provided.

### BRIEF DESCRIPTION OF THE DRAWINGS

Illustrative, non-limiting example embodiments will be more clearly understood from the following detailed description taken in conjunction with the accompanying drawings, in which:

FIG. 1 is a block diagram illustrating an example embodiment of a display device.

FIG. 2A is a circuit diagram illustrating an example embodiment of a pixel included in the display device of FIG. 1.

FIG. 2B is a diagram illustrating for describing an operation of the pixel of FIG. 2A.

FIG. 3A is a block diagram illustrating an example embodiment of a voltage controller included in the display device of FIG. 1.

FIG. 3B is a block diagram illustrating another example embodiment of a voltage controller included in the display device of FIG. 1.

FIG. 4A is a block diagram illustrating an example embodiment of a voltage generator included in the display device of FIG. 1.

FIG. 4B is a block diagram illustrating another example embodiment of a voltage generator included in the display device of FIG. 1.

FIG. 5A is a diagram illustrating an example embodiment of a gate signal generated in the voltage generator included in the display device of FIG. 1.

FIG. 5B is a diagram illustrating another example embodiment of a gate signal generated in the voltage generator included in the display device of FIG. 1.

FIG. 6 is a block diagram illustrating an electronic device that includes the display device of FIG. 1.

FIG. 7 is a diagram illustrating an example embodiment in which the electronic device of FIG. 6 is implemented as a smart phone.

FIG. 8 is a flowchart illustrating an example embodiment of a driving method of a display device.

### DETAILED DESCRIPTION

Hereinafter, the invention will be explained in detail with reference to the accompanying drawings.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The example term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The example terms “below” or “beneath” can, therefore, encompass both an orientation of above and below.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Example embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

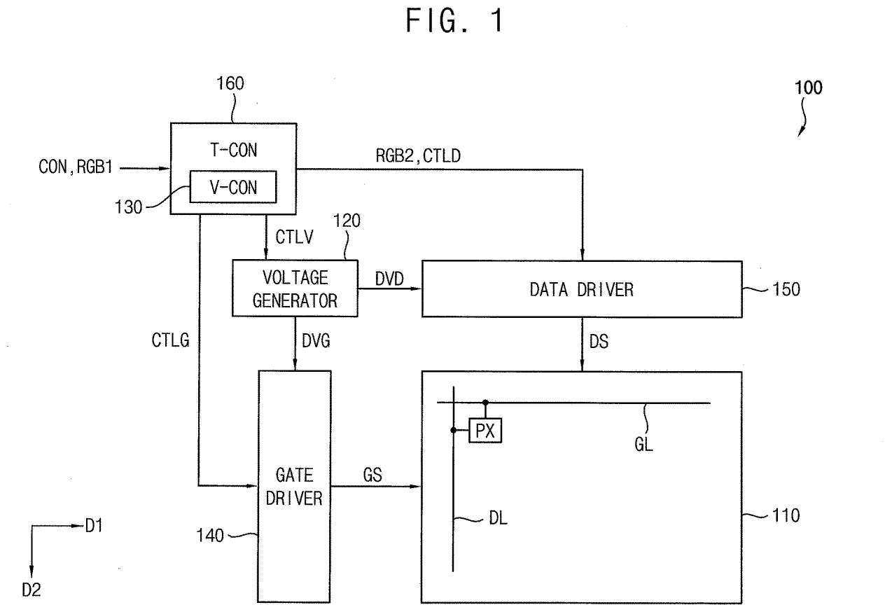

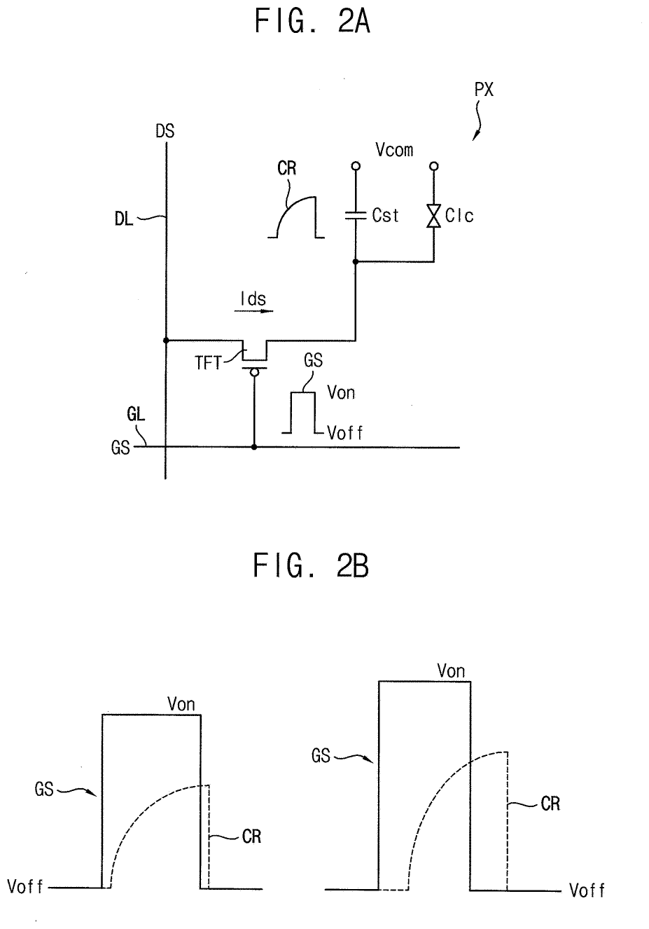

FIG. 1 is a block diagram illustrating a display device according to example embodiments. FIG. 2A is a circuit diagram illustrating an example of a pixel included in the display device of FIG. 1. FIG. 2B is a diagram illustrating for describing an operation of the pixel of FIG. 2A.

Referring to FIG. 1, a display device 100 may include a display panel 110, a voltage generator 120, a voltage controller 130, a gate driver 140, a data driver 150, and a timing controller 160.

The display panel 110 may include data lines DL, gate lines GL, and a plurality of pixels PX. The gate lines GL may extend in a first direction D1 and may be arranged in a second direction D2 perpendicular to the first direction D1. The data lines DL may extend in the second direction D2 and may be arranged in the first direction D1. The first direction D1 may be parallel to the parallel with a long side of the display panel 110, and the second direction D2 may be parallel with a short side of the display panel 110. Each of the pixels PX may be disposed in intersection regions of the data lines DL and the gate lines GL.

In an example embodiment, the display panel 110 may be a liquid crystal display (“LCD”) panel and the display device 100 may be an LCD device. Referring to FIG. 2A, each of the pixels PX may include a thin film transistor TFT electrically coupled to the gate line GL and the data line DL, a liquid capacitor Clc and a storage capacitor Cst coupled to the thin film transistor TFT. When the thin film transistor TFT turns on in response to a gate signal provided through the gate line GL, a voltage corresponding to a data signal DS may be charged in the storage capacitor Cst. Here, the gate signal GS may be a signal that swings between a gate on voltage Von and a gate off voltage Voff. A current Ids between drain-source of the thin film transistor TFT may increase as a voltage level of the gate on voltage Von of the gate signal GS increases (i.e., a voltage level of a voltage provided to the gate electrode of the thin film transistor TFT). Thus, the voltage CR charged in the pixel may increase as the voltage level of the gate on voltage Von of the gate signal GS increases as described in FIG. 2B. When the charging ratio of the pixel PX decreases, the luminance in a low grayscale range may be reversed. The charging ratio of pixel may be increased by increasing a voltage level of the gate on voltage Von of the gate signal GS. However, when the voltage level of the gate on voltage Von increases, a horizontal line defect may occur in a high temperature environment or in an image having high luminance as the voltage level of the gate on voltage Von increases. The display device 100 according to example embodiments may provide the gate on voltage Von having a first voltage level that satisfies a target charging ratio (e.g., 100%) of the pixel PX when a general image signal is provided, and provide the gate on voltage Von having a second voltage level lower than the first voltage level when the image signal that includes a predetermined reference pattern is provided.

Thus, the display device 100 may prevent a display defect.

Although the display device 100 that is the LCD device is described in FIGS. 2A and 2B, the display device may be an organic light emitting display device that includes the pixels that include a thin film transistor electrically coupled to the gate line GL and the data line DL, a storage capacitor coupled to the thin film transistor, a driving transistor coupled to the storage capacitor, and an organic light emitting diode coupled to the driving transistor.

Referring to FIG. 1, the voltage generator 120 may receive a direct current power from an external device and generate a plurality of voltages that is needed to drive the display panel. The voltage generator 120 may generate a gate driving voltage DVG provided to the gate driver 140 and a data driving voltage DVD provided to the data driver 150. In an example embodiment, the voltage generator 120 may generate the gate driving voltage DVG that includes the gate on voltage Von and the gate off voltage Voff and provide the gate driving voltage DVG to the gate driver 140, for example. The gate on voltage Von and the gate off voltage Voff are a driving voltage to generate the gate signal GS provided to the gate line GL disposed on the display panel 110. The voltage generator 120 may generate the data driving voltage DVD that includes an analog power voltage, a digital power voltage, a common voltage Vcom, etc., and provide the data driving voltage DVD to the data driver 150. The analog power voltage and the digital power voltage are a driving voltage to generate the data signal provided to the data line DL disposed on the display panel 110, and the common voltage Vcom is a driving voltage provided to the pixel PX.

The voltage generator 120 may generate the gate on voltage Von and the gate off voltage Voff. In some example embodiments, the voltage generator 120 may generate the gate on voltage Von having the first voltage level. Here, the first voltage level may be a voltage level that satisfies the target charging ratio (e.g., 100%) of the pixel PX. In other example embodiments, the voltage generator 120 may generate the gate off voltage Voff having a third voltage level. Here, the third voltage level may be a voltage level that satisfies the target charging ratio (e.g., 100%) of the pixel PX. Further, the voltage generator 120 may generate the common voltage Vcom having a fifth voltage level. Here, the fifth voltage level may be an optimum common voltage considering a kickback voltage of the display panel 110.

The voltage controller 130 may receive a first image signal RGB1 and generate a voltage control signal CTLV when the first image signal RGB1 includes the predetermined reference pattern. The voltage controller 130 may receive the first image signal RGB1 and store the first image signal RGB1 per frame. The voltage controller 130 may determine whether the first image signal RGB1 includes the reference pattern. The reference pattern may be a pattern that causes the display defect when the gate driving voltage DVG that satisfies the target charging ratio is provided. That is, the reference pattern may be the pattern that causes the display pattern as a swing depth of the gate signal GS increases. The reference pattern may cause a flicker defect, a crosstalk defect, a high temperature defect, etc., when the gate driving voltage DVG that satisfies the target charging ratio. In an example embodiment, the reference pattern may be a 2-dot pattern, a 1-dot pattern, a high luminance pattern, etc., for example. In some example embodiments, the voltage controller 130 may determine that the first image signal RGB1 includes the reference pattern when the number of data toggle is equal to or greater than a predetermined reference number. In other example embodiments, the voltage controller 130 may determine that the first image signal RGB1 includes the reference pattern when the number of data having a grayscale equal to or greater than a predetermined reference grayscale is equal to or greater than a predetermined reference number. In other example embodiments, the voltage controller 130 may determine whether the first image signal RGB1 includes the reference pattern by comparing the first image signal RGB1 and the reference pattern. The voltage controller 130 may output the voltage control signal CTLV when the reference pattern is detected more than a predetermined number of detection times. In an example embodiment, the voltage controller 130 may output the voltage control signal CTLV when the first image signal RGB1 that includes the reference pattern is detected more than 60 frames, for example. Although the voltage controller 130 disposed in the timing controller 160 is described in FIG. 1, the voltage controller 130 is not limited thereto. In an example embodiment, the voltage controller 130 may be electrically coupled to the timing controller 160, and may not be included in the timing controller 160, for example.

In some example embodiments, the voltage generator 120 may change the voltage level of the gate on voltage Von to a second voltage level lower than the first voltage level based on the voltage control signal CTLV output from the voltage controller 130. As described above, when the gate driving voltage DVG that satisfies the target charging ratio of the pixel PX is provided, the image signal that includes the reference pattern may cause the flicker defect, the crosstalk defect, the high temperature defect, etc. Thus, the voltage generator 120 may decrease the swing depth of the gate signal GS and prevent the defect occurred by increasing the swing depth of the gate signal GS by changing the voltage level of the gate on voltage Von to the second voltage level in response to the voltage control signal CTLV output from the voltage controller 130 when the reference pattern is detected. In other example embodiments, the voltage generator 120 may change the voltage level of the gate off voltage Voff to a fourth voltage level higher than the third voltage level based on the voltage control signal CTLV. The voltage generator 120 may decrease the swing depth of the gate signal GS and prevent the defect occurred by increasing the swing depth of the gate signal GS by changing the voltage level of the gate off voltage Voff to the fourth voltage level in response to the voltage control signal CTLV output from the voltage controller 130 when the reference pattern is detected. In other example embodiments, the voltage generator 120 may change the voltage level of the common voltage Vcom to a sixth voltage level lower than the fifth voltage level based on the voltage control signal CTLV output from the voltage controller 130. The voltage level of the optimum common voltage may be changed as the voltage level of the gate on voltage Von or the voltage level of the gate off voltage Voff is changed. The voltage level of the optimum common voltage Vcom changed by changing a voltage level of the gate on voltage Von or the voltage level of the gate off voltage Voff may be determined by a property of the display panel 110. The voltage level of the optimum common voltage Vcom may be experimentally determined and stored in the display device 100. In an example embodiment, the voltage generator 120 may decrease the voltage level of the common voltage by 0.05 volt (V) when the swing depth of the gate signal GS is decreased by 4V, for example.

The voltage generator 120 may sequentially changes the voltage level of the gate on voltage Von (or the gate off voltage Voff) based on the voltage control signal CTLV. The voltage generator 120 may sequentially change the voltage level of the gate on voltage Von from the first voltage level to the second voltage level based on the voltage control signal CTLV. In an example embodiment, the voltage generator 120 may change the voltage level of the gate on voltage Von at a speed of 1V/sec, for example. The voltage generator 120 may sequentially change the voltage level of the gate off voltage Voff from the third voltage level to the fourth voltage level based on the voltage control signal CTLV. In an example embodiment, the voltage generator 120 may change the voltage level of the gate off voltage Voff at a speed of 1V/sec, for example.

The gate driver 140 may generate the gate signal GS based on the gate driving voltage DVG provided from the voltage generator 120 and the gate control signal CTLG provided from the timing controller 160. The gate driver 140 may receive the gate driving voltage DVG that includes the gate on voltage Von and the gate off voltage Voff from the voltage generator 120. Further, the gate driver 140 may generate the gate signal GS that swings between the gate on voltage Von and the gate off voltage Voff based on the gate driving voltage DVG and the gate control signal CTLG. The gate driver 140 may sequentially provide the gate signal GS to the gate lines GL disposed on the display panel 110. The gate driver 140 may be simultaneously provided with the transistors of the pixels and may be disposed (e.g., mounted) on the display panel 110 in an amorphous silicon TFT gate driver circuit (“ASG”) or an oxide silicon TFT gate driver circuit (“OSG”). In an alternative example embodiment, the gate driver 140 may be implemented as a plurality of driving chips and disposed (e.g., mounted) on a non-display area of the display panel 110 in a chip on glass (“COG”). In an alternative example embodiment, the gate driver 140 may be implemented as a plurality of driving chips, disposed (e.g., mounted) on a flexible printed circuit board, and coupled to the display panel 110 in a tape carrier package (“TCP”).

The data driver 150 may provide the data signal DS to the pixels PX through the data line DL. The data driver 150 may generate the data signal DS based the data control signal CTLD and a second image signal RGB2 provided from the timing controller 160 and the data driving voltage DVD provided form the voltage generator 120. The data control signal CTLD may include a horizontal start signal and a data clock signal. The data driving voltage DVD may include the analog driving voltage, the digital driving voltage, the common voltage Vcom, etc. The data driver 150 may generate the data signal DS corresponding to the second image signal RGB2 based on the analog driving voltage and the digital driving voltage provided from the voltage generator 120 and output the data signal DS to the data lines DL based on the horizontal start signal and the data clock signal provided from the timing controller 160. Further, the data driver 150 may apply the common voltage Vcom provided from the voltage generator 120 to a common electrode of the display panel 110.

The timing controller 160 may generate the control signals CTLG and CTLD that control the gate driver 140 and the data driver 150, respectively. The timing controller 160 may receive the control signal CON from the external device. The timing controller 160 may generate the gate control signal CTLG provided to the gate driver 140 based on the control signal CON. The gate control signal CTLG may include a vertical start signal and a gate clock signal. The timing controller 160 may generate the data control signal CTLD provided to the data driver 150 based on the control signal CON. The data control signal CTLD may include a horizontal start signal and a data clock signal. Further, the timing controller 160 may convert the first image signal RGB1 provided from the external device to the second image signal RGB2. In an example embodiment, the timing controller 160 may convert the first image signal RGB1 to the second image signal RGB2 by adjusting an algorithm for compensating the display quality, for example. The timing controller 160 may provide the gate control signal CTLG to the gate driver 140 and provide the data control signal CTLD and the second image signal RGB2 to the data driver 150.

As described above, the display device 100 according to example embodiments may improve display quality of the display device 100 by providing the gate on voltage Von having the first voltage level that satisfies the target charging ratio of the pixel when the first image signal RGB1 that does not include the reference pattern is provided. Further, the display device 100 may prevent the display defect by providing the gate on voltage Von having the second voltage level lower than the first voltage level when the first image signal RGB1 that includes the reference pattern is provided.

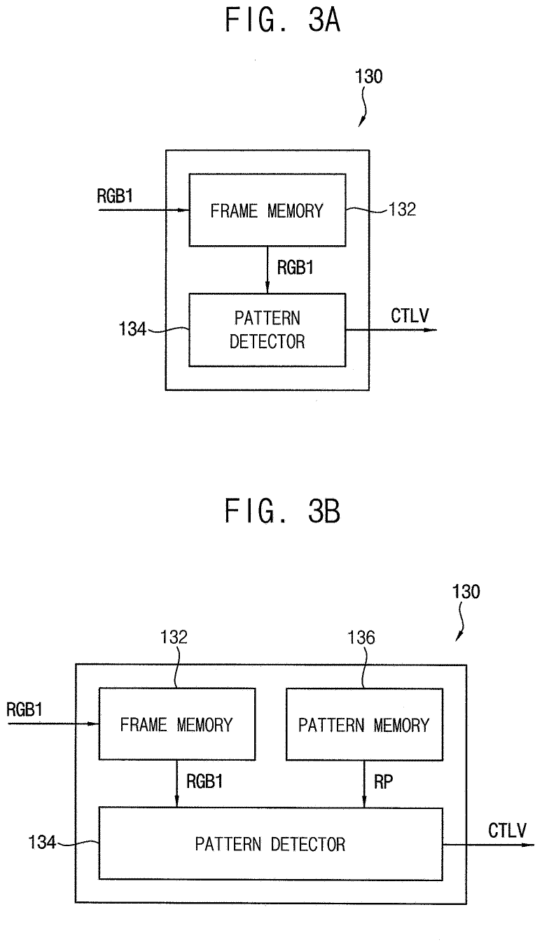

FIG. 3A is a block diagram illustrating an example of a voltage controller included in the display device of FIG. 1. FIG. 3B is a block diagram illustrating another example of a voltage controller included in the display device of FIG. 1.

Referring to FIG. 3A, the voltage controller 130 may include a frame memory 132 and a pattern detector 134. The frame memory 132 may store the first image signal RGB1 per frame. The pattern detector 134 may determine whether the first image signal RGB1 includes the reference pattern RP. In some example embodiments, the pattern detector 134 may determine that the first image signal RGB1 includes the reference pattern RP when the number of data toggle is equal to or greater than the predetermined reference number. In other example embodiments, the pattern detector 134 may determine the first image signal RGB1 includes the reference pattern RP when the number of the data having a grayscale equal to or greater than the predetermined grayscale is equal to or greater than the predetermined reference number. In an example embodiment, the pattern detector 134 may determine that the first image signal RGB1 includes the reference pattern RP when the number of the data having a grayscale equal to or greater than 200 grayscale is equal to or greater than ⅓ of all pixels, for example. The pattern detector 134 may output the voltage control signal CTLV when the reference pattern RP is detected more than the predetermined number of detection times. In an example embodiment, the voltage controller 130 may output the voltage control signal CTLV when the first image signal RGB1 that includes the reference pattern RP is detected more than 60 frames, for example.

Referring to FIG. 3B, the voltage controller 130 may include a frame memory 132, a pattern memory 136, and a pattern detector 134. The pattern memory 136 may store the reference pattern RP. The pattern detector 134 may compare the first image signal RGB1 and the reference pattern RP stored in the pattern memory 136. The pattern detector 134 may determine that the first reference signal RGB1 includes the reference pattern RP when the first image signal RGB1 is the same as the reference pattern RP. The pattern detector 134 may output the voltage control signal CTLV when the reference pattern RP is detected more than the predetermined number of detection times. In an example embodiment, the voltage controller 130 may output the voltage control signal CTLV when the first image signal RGB1 that includes the reference pattern RP is detected more than 60 frames, for example.

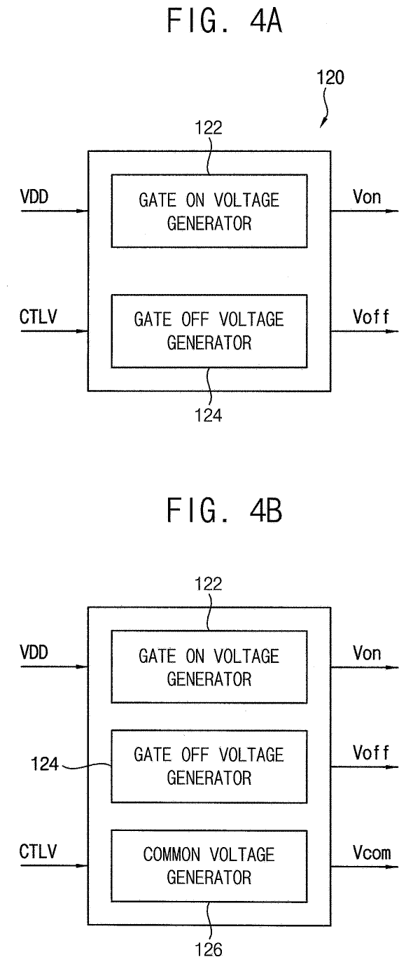

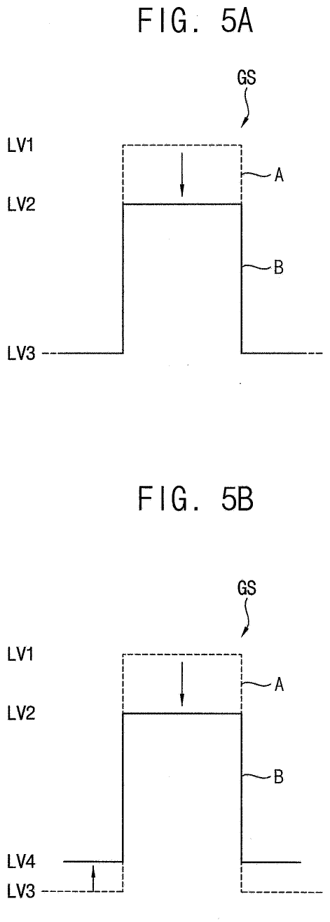

FIG. 4A is a block diagram illustrating an example of a voltage generator included in the display device of FIG. 1. FIG. 4B is a block diagram illustrating another example of a voltage generator included in the display device of FIG. 1.

The voltage generator 120 may receive the direct current (“DC”) power VDD from the external device and generate the plurality of voltages needed to drive the display panel.

Referring to FIG. 4A, the voltage generator 120 may include a gate on voltage generator 122 and a gate off voltage generator 124. The gate on voltage generator 122 may generate the gate on voltage Von having the first voltage level based on the DC power VDD. The gate on voltage generator 122 may change the voltage level of the gate on voltage Von to the second voltage level based on the voltage control signal CTLV provided form the gate controller. The gate on voltage generator 122 may sequentially change the gate on voltage Von from the first voltage level to the second voltage level during a predetermined time. The gate off voltage generator 124 may generate the gate off voltage Voff having the third voltage level based on the DC power VDD. The gate off voltage generator 124 may change the voltage level of the gate off voltage Voff to the fourth voltage level based on the voltage control signal CTLV provided from the gate controller. The gate off voltage generator 124 may sequentially change the gate off voltage Voff from the third voltage level to the fourth voltage level during a predetermined time.

Referring to FIG. 4B, the voltage generator 120 ma include a gate on voltage generator 122, a gate off voltage generator 124, and a common voltage generator 126. The gate on voltage generator 122 and the gate off voltage generator 124 in FIG. 4B may have the same or similar structure to that of the gate on voltage generator 122 and the gate off voltage generator 124 in FIG. 4A. The common voltage generator 126 may generate the common voltage Vcom having the fifth voltage level based on the DC power VDD. Here, the fifth voltage level is a voltage level of the optimum common voltage to which the kickback voltage of the display panel is compensated when the gate on voltage Von having the first voltage level that satisfies the target charging ratio of the pixel. When the gate on voltage Von and the gate off voltage Voff are changed based on the voltage control signal CTLV, the kickback voltage of the display panel may be changed. Thus, the voltage level of the optimum common voltage may be changed. The common voltage generator 126 may change the voltage level of the common voltage Vcom to compensate the kickback voltage that is changed according to the change of the voltage level of the gate on voltage Von and the gate off voltage Voff. In some example embodiments, the common voltage generator 126 may change the voltage level of the common voltage level to the sixth voltage level based on the voltage control signal CTLV provided from the gate controller. In other example embodiments, the common voltage generator 126 may change the voltage level of the common voltage Vcom based on the voltage level of the gate on voltage Von provided form the gate on voltage generator 122. In an example embodiment, when the voltage level of the gate on voltage Von decreases by 0.4V, the common voltage generator 126 may generate the common voltage Vcom of which the voltage level decreases by 0.05V, for example.

FIG. 5A is a diagram illustrating an example of a gate signal generated in the voltage generator included in the display device of FIG. 1. FIG. 5B is a diagram illustrating another example of a gate signal generated in the voltage generator included in the display device of FIG. 1.

In a case A that the general image signal (i.e., the image signal that does not include the reference pattern) is provided to the voltage controller, the voltage generator may generate the on voltage having the first voltage level LV1 and the gate off voltage having the third voltage level LV3. Referring to FIGS. 5A and 5B, the gate driver may generate the gate signal GS that swings between the first voltage level LV1 and the third voltage level LV3 based on the gate on voltage and the gate off voltage provided from the voltage generator. Here, the gate signal GS that swings between the first voltage level LV1 and the third voltage level LV3 may satisfy the target charging ratio of the pixel. In an example embodiment, the first voltage level LV1 may be 35V and the third voltage level LV3 may be −7.5V, for example.

In some example embodiments, in case B that the voltage controller determines that the image signal includes the reference pattern, the voltage control signal may be provided to the voltage generator. The voltage generator may generate the gate on voltage having the second voltage level LV2 and the gate off voltage having the third voltage level LV3 based on the voltage control signal. Referring to FIG. 5A, the gate driver may generate the gate signal GS that swings between the second voltage level LV2 and the third voltage level LV3 based on the gate on voltage and the gate off voltage provided from the voltage generator. In an example embodiment, the second voltage level LV2 may be 28V, for example. In this case, the display defect occurred in the image signal that includes the reference pattern may improve because the swing depth of the gate signal GS that swings between the second voltage level LV2 and the third voltage level LV3 is less than the swing depth of the gate signal GS that swings between the first voltage level LV1 and the third voltage level LV3.

In other example embodiments, the voltage generator may generate the gate on voltage having the second voltage level LV2 and the gate off voltage having the fourth voltage level LV4 based on the voltage control signal. Referring to FIG. 5B, the gate driver may generate the gate signal GS that swings between the second voltage level LV2 and the fourth voltage level LV4 based on the gate on voltage and the gate off voltage provided from the voltage generator. In an example embodiment, the second voltage level LV2 may be 28V and the fourth voltage level may be 6.5V, for example. In this case, the display defect occurred in the image signal that includes the reference pattern may improve because the swing depth of the gate signal GS that swings between the second voltage level LV2 and the fourth voltage level LV4 is less than the swing depth of the gate signal GS that swings between the first voltage level LV1 and the third voltage level LV3.

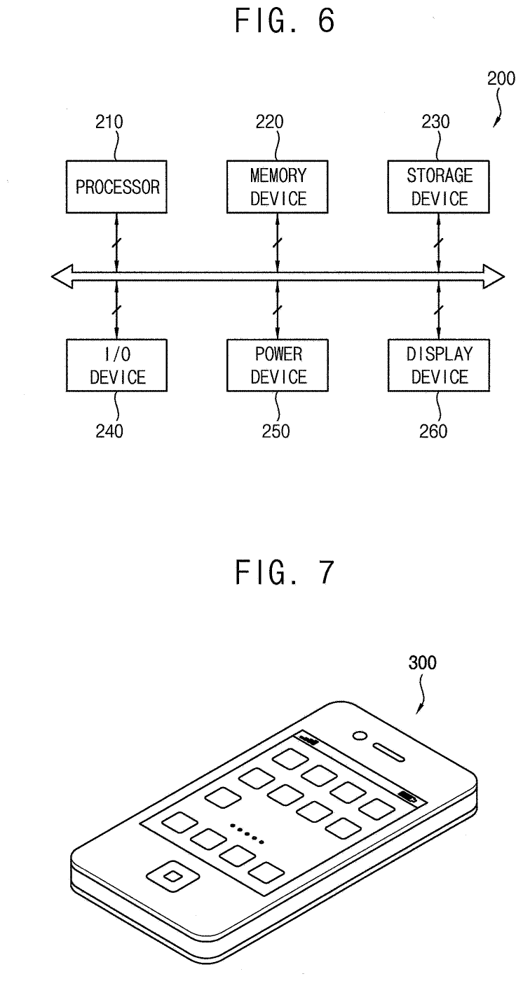

FIG. 6 is a block diagram illustrating an electronic device that includes the display device of FIG. 1. FIG. 7 is a diagram illustrating an example embodiment in which the electronic device of FIG. 6 is implemented as a smart phone.

Referring to FIGS. 6 and 7, an electronic device 200 may include a processor 210, a memory device 220, a storage device 230, an input/output (“I/O”) device 240, a power device 250, and a display device 260. Here, the display device 260 may correspond to the display device 100 of FIG. 1. In addition, the electronic device 200 may further include a plurality of ports for communicating a video card, a sound card, a memory card, a universal serial bus (“USB”) device, other electronic device, etc. Although it is illustrated in FIG. 7 that the electronic device 200 is implemented as a smart phone 300, a kind of the electronic device 200 is not limited thereto.

The processor 210 may perform various computing functions. The processor 210 may be a microprocessor, a central processing unit (“CPU”), etc. The processor 210 may be coupled to other components via an address bus, a control bus, a data bus, etc. Further, the processor 210 may be coupled to an extended bus such as surrounded component interconnect (“PCI”) bus. The memory device 220 may store data for operations of the electronic device 200. In an example embodiment, the memory device 220 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, etc., and/or at least one volatile memory device such as a dynamic random access memory (“DRAM”) device, a static random access memory (“SRAM”) device, a mobile DRAM device, etc., for example. In an example embodiment, the storage device 230 may be a solid stage drive (“SSD”) device, a hard disk drive (“HDD”) device, a CD-ROM device, etc., for example.

The I/O device 240 may be an input device such as a keyboard, a keypad, a touchpad, a touch-screen, a mouse, etc., and an output device such as a printer, a speaker, etc. In some example embodiments, the display device 260 may be included in the I/O device 240. The power device 250 may provide a power for operations of the electronic device 200. The display device 260 may communicate with other components via the buses or other communication links.

As described above, the display device 260 may include a display panel, a voltage generator, a voltage controller, a gate driver, a data driver, and a timing controller. The display panel may include data lines, gate lines, and a plurality of pixels. In some example embodiments, the display panel may be an LCD panel and the display device 260 may be a LCD device. In other example embodiments, the display panel may be an organic light emitting display panel and the display device 260 may be an organic light emitting display device. When the display device 260 is the LCD device, each of the pixels disposed on the display panel may include a thin film transistor electrically coupled to the gate line and the data line, a liquid crystal capacitor and a storage capacitor coupled to the thin film transistor. When the thin film transistor turns on in response to a gate signal provided through the gate line, a voltage corresponding to the data signal may be charged in the storage capacitor. Here, the gate signal may be a signal that swings between the gate on voltage and the gate off voltage. A current of drain-source may increase as a voltage difference between a gate electrode and a source electrode of the thin film transistor increases. Thus, a charging ratio of the storage capacitor may increase as a voltage level of the gate on voltage of the gate signal increases. Here, when the image signal includes a predetermined reference pattern, a display defect may occur because a swing depth of the gate signal increases. The reference pattern may be a 2-dot pattern, a 1-dot pattern, a high luminance pattern, etc. that causes a flicker defect, a crosstalk defect, a high temperature defect, etc. The display device 260 according to example embodiments may generate the gate signal that includes the gate on voltage having a first voltage level that increases the charging ratio of the pixel when the general image signal is provided. Thus, the display quality may improve in the general image signal. The display device may decrease the voltage level of the gate on voltage of the gate signal to a second voltage level lower than the first voltage level when the image signal includes the reference pattern. Thus, the display defect occurred in the image signal that includes the reference pattern may be prevented. The voltage generator may generate the gate on voltage having the first voltage level and the gate off voltage having a third voltage level. The voltage controller may receive the image signal and determine whether the image signal includes the reference pattern. The voltage controller may output the voltage control signal when the image signal includes the reference pattern more than a predetermined number of reference times. The voltage generator may change the voltage level of the gate on voltage from the first voltage level to the second voltage level and the voltage level of the gate off voltage from the third voltage level to a fourth voltage level. The voltage generator may sequentially changes the voltage level of the gate on voltage and the voltage level of the gate off voltage during a predetermined time. The gate driver may generate the gate signal based on the gate on voltage and the gate off voltage provided from the voltage generator. When the general image signal is provided to the display device 260, the gate driver may generate the gate signal that swings between the first voltage level and the third voltage level. When the image signal that includes the reference pattern is provided to the display device 260, the gate driver may generate the gate signal that swings between the second voltage level and the third voltage level, or between the second voltage level and the forth voltage level. Here, an optimum common voltage may be changed as the voltage level of the gate on voltage is changed. The display device 260 may change the voltage level of the common voltage based on the change of the voltage level of the gate on voltage. In an example embodiment, the display device 260 may decrease the voltage level of the common voltage as the voltage level of the gate on voltage decreases, for example.

As described above, the electronic device 200 may include the display device 260 that generates the gate signal based on the gate on voltage having the first voltage level that increases the charging ratio of the storage capacitor when the general image signal is provided and generates the gate signal based on the gate on voltage having the second voltage level lower than the first voltage level when the image signal that includes the reference pattern is provided. Thus, display device 260 may improve the display quality of an image corresponding to the general image signal, and prevent the display defect from occurring in an image corresponding to the image signal that includes the reference pattern.

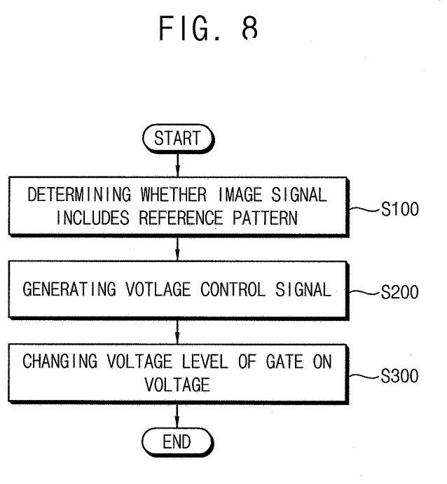

FIG. 8 is a flowchart illustrating a driving method of a display device according to example embodiments.

Referring to FIG. 8, a driving method of a display device may include an operation determining whether an image signal includes a reference pattern S100, an operation of generating a voltage control signal S200, and an operation of changing a voltage level of a gate driving voltage S300.

The driving method of the display device according to example embodiments may determine whether the image signal includes the reference pattern S100. The display device may receive the image signal from an external device and determine whether the image signal includes the predetermined reference pattern. The reference pattern may cause display defects when the gate signal that satisfies a target charging ratio of a storage capacitor of a pixel is provided. That is, the reference pattern may cause the display defects as a swing depth of the gate signal increases. In some example embodiments, the display device may determine that the image signal includes the reference pattern when the number of data toggle is equal to or greater than a predetermined reference number in the image signal. In other example embodiments, the display deice may determine that the image signal includes the reference pattern when the number of data having grayscale equal to or greater than a predetermined reference grayscale is equal to or greater than a predetermined reference number in the image signal. In other example embodiment, the display device may determine whether the image signal includes the reference pattern by comparing the image signal to the reference pattern stored in the display device.

The driving method of the display device according to example embodiments may generate the voltage control signal when the image signal includes the reference pattern S200. The display device may generate the voltage control signal that changes the voltage level of the gate on voltage of the gate signal when the image signal includes the reference pattern. The display device may output the voltage control signal when the reference pattern is detected more than a predetermined number of detection times.

The driving method of the display device according to example embodiments may change the voltage level of the gate on voltage having the first voltage level to a second voltage level lower than the first voltage level based on the voltage control signal S300. Here, the first voltage level may satisfy the target charging ratio (e.g., 100%) of the storage capacitor included in the pixel. The display device may generate the gate signal that includes the gate on voltage having the first voltage level when the general image signal is provided, and generate the gate signal that includes the gate on voltage having the second voltage level lower than the first voltage level when the image signal that includes the reference pattern is detected. The display device may decrease the swing depth of the gate signal by decreasing the voltage level of the gate on voltage when the image signal that includes the reference pattern is detected.

The driving method of the display device according to example embodiments may change the voltage level of the gate off voltage having a third voltage level to a fourth voltage level higher than the third voltage level based on the voltage control signal. The display device may decrease the swing depth of the gate signal by increasing the voltage level of the gate off voltage when the image signal that includes the reference pattern is detected.

The driving method of the display device according to example embodiments may change the voltage level of a common voltage having a fifth voltage level to a sixth voltage level lower than the fifth voltage level. The display device may change the voltage level of the common voltage based on the voltage control signal because the voltage level of an optimum common voltage is changed when the voltage level of the gate on voltage and the voltage level of the gate off voltage are changed.

As described above, the driving method of the display device according to example embodiments may improve the display quality by generating the gate signal that includes the gate on voltage having the first voltage level that satisfies the target charging ratio of the storage capacitor when the image signal does not include the reference pattern. Further, the driving method of the display device according to example embodiments may improve the display defect by generating the gate signal that includes the gate on voltage having the second voltage level lower than the first voltage level when the image signal includes the reference pattern.

The invention may be applied to a display device and an electronic device including the display device. In an example embodiment, the invention may be applied to a computer monitor, a laptop, a digital camera, a cellular phone, a smart phone, a smart pad, a television, a personal digital assistant (“PDA”), a portable multimedia player (“PMP”), a MP3 player, a navigation system, a game console, a video phone, etc., for example.

The foregoing is illustrative of example embodiments and is not to be construed as limiting thereof. Although example embodiments have been described, those skilled in the art will readily appreciate that many modifications are possible in the example embodiments without materially departing from the novel teachings and advantages of the invention. Accordingly, all such modifications are intended to be included within the scope of the invention as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A display device comprising:
a display panel including a plurality of pixels;
a voltage generator which generates a gate on voltage having a first voltage level which satisfies a target charging ratio of a pixel of the plurality of pixels;
a voltage controller which receives an image signal and generates a voltage control signal when the image signal includes a predetermined reference pattern;
a gate driver which generates a gate signal provided to the plurality of pixels based on the gate on voltage;
a data driver which generates a data signal provided to the plurality of pixels based on the image signal; and
a timing controller which generates control signals which control the gate driver and the data driver,
wherein the voltage generator changes the gate on voltage to have a second voltage level lower than the first voltage level based on the voltage control signal.

2. The display device of claim 1, wherein the voltage controller outputs the voltage control signal when the predetermined reference pattern is detected more than a predetermined number of detection times.

3. The display device of claim 1, wherein the voltage generator sequentially changes the gate on voltage from the first voltage level to the second voltage level based on the voltage control signal.

4. The display device of claim 1, wherein the voltage generator further generates a gate off voltage having a third voltage level which satisfies the target charging ratio of the pixel, and changes the gate off voltage to have a fourth voltage level higher than the third voltage level based on the voltage control signal.

5. The display device of claim 1, wherein the voltage generator further generates a common voltage having a third voltage level which is an optimum common voltage of the pixel, and changes the common voltage to have a fourth voltage level lower than the third voltage level based on the voltage control signal.

6. The display device of claim 1, wherein the voltage controller includes:
a frame memory which stores the image signal per frame; and
a pattern detector which determines whether the image signal includes the predetermined reference pattern.

7. The display device of claim 6, wherein the pattern detector determines that the image signal includes the predetermined reference pattern when a number of data toggle is equal to or greater than a predetermined reference number in the image signal.

8. The display device of claim 6, wherein the pattern detector determines that the image signal includes the predetermined reference pattern when a number of data having a grayscale equal to or greater than a predetermined reference grayscale is equal to or greater than a predetermined reference number in the image signal.

9. The display device of claim 6, wherein the voltage controller further includes a pattern memory,
wherein the pattern memory determines whether the image signal includes the predetermined reference pattern by comparing the image signal and the predetermined reference pattern stored in the pattern memory.

10. The display device of claim 1, wherein the voltage controller is included in the timing controller.

11. The display device of claim 1, wherein the voltage controller is coupled to the timing controller.

12. The display device of claim 1, wherein the predetermined reference pattern is a pattern which causes a display defect when the gate on voltage having the first voltage level is provided to the pixel.

13. A driving method of a display device, the driving method comprising:
determining whether an image signal includes a predetermined reference pattern;
generating a voltage control signal when the image signal includes the predetermined reference pattern; and
changing a voltage level of a gate on voltage having a first voltage level which satisfies a target charging ratio of a pixel to a second voltage level lower than the first voltage level based on the voltage control signal.

14. The driving method of claim 13, wherein when the predetermined reference pattern is detected more than a predetermined number of detection times, the voltage control signal is output.

15. The driving method of claim 13, further comprising:
changing a voltage level of a gate off voltage having a third voltage level which satisfies the target charging ratio to a fourth voltage level higher than the third voltage level based on the voltage control signal.

16. The driving method of claim 13, further comprising:
changing a voltage level of a common voltage having a third voltage level which is an optimum common voltage level to a fourth voltage level lower than the third voltage level based on the voltage control signal.

17. The driving method of claim 13, wherein the determining whether the image signal includes the predetermined reference pattern includes:
determining that the image signal includes the predetermined reference pattern when a number of data toggle is equal to or greater than a predetermined reference number in the image signal.

18. The driving method of claim 13, wherein the determining whether the image signal includes the predetermined reference pattern includes:
determining that the image signal includes the predetermined reference pattern when a number of data having a grayscale equal to or greater than a predetermined reference grayscale is equal to or greater than a predetermined reference number in the image signal.

19. The driving method of claim 13, wherein the determining whether the image signal includes the predetermined reference pattern includes:
comparing the image signal to the predetermined reference pattern stored in the display device.

20. The driving method of claim 13, wherein the predetermined reference pattern is a pattern which causes a display defect when the gate on voltage having the first voltage level is provided to the pixel.
